(19) United States
(12) Patent Application Publication
(10) Pub. No.: US 2005/0050319 A1
(43) Pub. Date: Mar. 3, 2005

(54) License control for web applications

(76) Inventor: Zeev Suraski, Givatayim (IL)

Correspondence Address: TOWNSEND AND TOWNSEND AND CREW, LLP, TWO EMBARCADERO CENTER, EIGHTH FLOOR, SAN FRANCISCO, CA, 94111-3834, US

(21) Appl. No.: 10/639,837

(22) Filed: Aug. 12, 2003

(51) Int. Cl. H04L 9/32; G06F 12/14

(52) U.S. Cl. 713/164; 713/201

(57) ABSTRACT

A method for controlling access to a software application running on a server includes providing respective identifiers to a plurality of clients seeking to access the application on the server. A list of the identifiers of the clients who are entitled to access the application is maintained on the server. The list includes a predetermined number of slots. Upon receiving a request submitted by a given client to access the application, the server permits the given client to access the application only if the identifier assigned to the client, which is included in the request, appears on the list or if at least one of the slots on the list is available to receive the identifier.

### FIELD OF THE INVENTION

The present invention relates generally to managing the use of software, and specifically to license control in network-based client/server applications.

### BACKGROUND OF THE INVENTION

Software licenses are a well-known method for preventing unauthorized use and copying of computer programs. Typically, a computer user who purchases a software program under license is provided with a software key or license file, which must be input to the computer at installation of the software and maintained on the computer to enable subsequent use of the program. When a user, such as an enterprise, has multiple computers on which the software is to run, the user must generally purchase a separate license and key for each computer.

U.S. Pat. No. 5,390,297, to Barber et al., whose disclosure is incorporated herein by reference, describes a system for controlling the number of concurrent copies of a program in a network based on the number of available licenses. The system allows licenses to be made available for use at multiple nodes in the network, wherein the number of licenses may be less than the number of nodes. If a local node has a valid license file with an unexpired, available license, a license manager on the local node allows the program to be executed at that node. If no such license is available, the license manager searches the other nodes for a license and, when it finds an available license on a remote node, transfers the license from the remote node to the local node. The license is erased from the license file on the remote node. The number of copies of the program that are authorized for simultaneous execution on the nodes of the network is thus limited to the number of licenses that have been loaded into the license files on the network.

Licensing of Web server applications is also known in the art. For example, the SafeGuard Suite™, produced by Zend Technologies Ltd. (Ramat Gan, Israel), allows software vendors to limit the distribution and use of applications written in the PHP Web scripting language. By encoding their applications using the Zend Encoder component and enabling licensing requirements in the Encoder, software vendors can create versions of their applications that will run only if accompanied by a valid software license. This license is held in a license file, which is digitally signed by the creator of the application. License files can be configured to disable application use beyond a specified expiration date, as well as to lock the application to a specific Web server (based on unique hardware or software characteristics of the machine) or to a specific Internet Protocol (IP) address or a range of IP addresses.

It is known in the art to limit by license the number of simultaneous client connections that can be maintained by a network server. For example, the Advanced Server produced by the Santa Cruz Operation Inc. (Santa Cruz, Calif.) has a capability of this sort, as does the Macromedia Flash Communication Server, produced by Macromedia Inc. (San Francisco, Calif.).

Electronic content may also be licensed to limit the number of consumers who are allowed to access the content simultaneously via a network. A system of this sort is described, for example, by Glassman et al., in U.S. Pat. No. 6,453,305, whose disclosure is incorporated herein by reference. A consumer initially acquires vendor scrip, either from a broker or from the vendor of the content. The consumer presents the vendor scrip to the vendor along with a request to access the content. The vendor determines whether a license to the content is available for use by the consumer, depending on the number of other consumers currently having licenses. If this number is less than the maximum specified in the applicable content license agreement, the consumer is allowed to access the content.

### SUMMARY OF THE INVENTION

Methods of software licensing known in the art are designed to limit the number of machines on which a licensed application is permitted to run at any given time. These licensing systems are not able, however, to control the number of clients who may simultaneously access an application that is running on a given machine. Thus, for example, while the above-mentioned SafeGuard Suite license file may permit a Web application to run only on a single licensed server, it is not capable of restricting the number of clients who may concurrently access the application on the server through their Web browsers. Other methods known in the art, as described in the Background of the Invention, are able to control the number of connections a server may establish or the number of consumers who may receive certain content, but are not capable of directly regulating client access to a particular application.

Embodiments of the present invention overcome these limitations of the prior art by enabling an application provider to control the number of clients who may concurrently access the application on a given server or cluster of servers. Based on this capability, the application provider can sell software under a license that specifies not only the number of servers on which the application may run, but also the number of clients that may be served simultaneously. Software vendors can apply this sort of licensing to realize revenues on the volume of user traffic that their applications generate.

In order to control client access to an application program on a server, a license control component on the server causes the server to issue a temporary identifier to each client who attempts to access the application. In the context of Web applications running on HTTP servers, the server may issue session cookies (also known as transient or temporary cookies) for this purpose. Each subsequent request by the client to access the application on the server is accompanied by a copy of the temporary identifier. The server maintains a list of currently-active temporary identifiers in memory. The number of available slots on the list is equal to the maximum number of concurrent clients authorized by the application provider. This maximum number is typically defined in a license file that is supplied with the software by the application provider. When the list is full, additional clients may not access the application until one of the current clients has logged off or timed out.

There is therefore provided, in accordance with an embodiment of the present invention, a method for controlling access to a software application, the method including:
receiving software code in an encoded form from a software vendor, for use in running the software application on a server;
decoding the software code subject to terms of a license determined by the software vendor so as to run the software application on the server;
providing respective identifiers to a plurality of clients seeking to access the application on the server;
maintaining a list of the identifiers of the clients who are entitled to access the application on the server, the list including a number of slots determined by the terms of the license;
receiving a request submitted by a given client among the plurality of the clients to access the application on the server, the request including a given identifier issued to the given client; and
permitting the given client to access the application, responsively to the request, only if the given identifier appears on the list or if at least one of the slots on the list is available to receive the given identifier.

In an aspect of the invention, the number of slots is defined in a license file provided by the software vendor, and decoding the software code includes decoding the software code using a license control component, which reads the license file and maintains the list of the identifiers. In a disclosed embodiment, the software code is written in a scripting language, and is then encoded by the software vendor.

In some embodiments, providing the respective identifiers includes sending cookies to the clients over a network, and receiving the request includes receiving a message from the given client over the network, wherein the message includes one of the cookies that is issued to the given client. Typically, the cookies include session cookies, and receiving the message includes receiving a Hypertext Transfer Protocol (HTTP) request. Additionally or alternatively, providing the respective identifiers includes generating a uniform resource locator (URL) indicative of the given identifier issued to the given client, so as to cause the given client to insert the given identifier in the HTTP request.

In a disclosed embodiment, providing the respective identifiers includes receiving a first request from the given client to access the application on the server, wherein the first request does not include a valid identifier, and issuing the given identifier to the given client in response to the first request, wherein receiving the request including the given identifier includes receiving a second request from the given client to access the application subsequent to the first request, the second request including the given identifier. Typically, maintaining the list includes entering the given identifier in one of the slots on the list, if at least one of the slots is available, after receiving the second request.

Additionally or alternatively, maintaining the list includes, upon determining that the given identifier does not appear on the list but one of the slots on the list is available, and permitting the given client to access the application, entering the given identifier in the available one of the slots.

Further additionally or alternatively, permitting the given client to access the application includes denying the given client access to the application when all the slots on the list are occupied by the identifiers of others of the clients who are accessing the application. In a disclosed embodiment, maintaining the list includes entering timestamps in the slots, indicating respective times at which the clients last accessed the application, and permitting the given client to access the application includes clearing one of the slots that contains a stale timestamp, and permitting the given client to access the application while entering the given identifier in the one of the slots that has been cleared.

There is further provided, in accordance with an embodiment of the present invention, a method for controlling access to a software application, the method including:
running the software application on a server;
issuing respective session cookies from the server to a plurality of clients seeking to access the application on the server, each of the session cookies including a unique identifier;
maintaining a list of the identifiers of the clients who are entitled to access the application on the server, the list including a predetermined number of slots;
receiving at the server a message from a given client among the plurality of the clients, the message comprising a request submitted by the client to access the application on the server and including a given session cookie issued to the given client; and
permitting the given client to access the application, responsively to the request, only if the identifier included in the given session cookie appears on the list or if at least one of the slots on the list is available to receive the given identifier.

There is also provided, in accordance with an embodiment of the present invention, a method for controlling access to a software application, the method including:
providing a software application under license from a software vendor to an operator of a server, the application including software code provided in an encoded form and a license file, which specifies license conditions including a limitation on a maximum number of clients permitted to access the application concurrently on the server;
running the application on the server by decoding the software code using a license control component, which permits the application to run subject to the conditions specified in the license file;
receiving a request from a client to access the application on the server; and
processing the request using the license control component, so as to permit the client to access the application subject to the limitation on the maximum number of the clients.

Typically, receiving the request includes receiving a message including an identifier issued to the client by the server, and processing the request includes comparing the identifier to a list of identifiers maintained on the server, the list having a number of slots for receiving the identifiers equal to the maximum number of the clients specified in the license file. The maximum number of the clients may be substantially less than a total number of the clients who may access the application on the server at different times.

There is additionally provided, in accordance with an embodiment of the present invention, a server for running a software application, the server including:
a memory, which is arranged to store software code provided in an encoded form by a software vendor, for use in running the software application; and
a processor, which is adapted to decode the software code subject to terms of a license determined by the software vendor so as to run the software application, and to provide respective identifiers to a plurality of clients seeking to access the application on the server while maintaining in the memory a list of the identifiers of the clients who are entitled to access the application on the server, the list including a number of slots determined by the terms of the license,
wherein the processor is further adapted, upon receiving a request submitted by a given client among the plurality of the clients to access the application on the server, the request including a given identifier issued to the given client, to permit the given client to access the application, responsively to the request, only if the given identifier appears on the list or if at least one of the slots on the list is available to receive the given identifier.

There is moreover provided, in accordance with an embodiment of the present invention, a server for running a software application, the server including:
a memory; and
a processor, which is adapted to run the software application, and which is further adapted to issue respective session cookies to a plurality of clients seeking to access the application on the server, each of the session cookies including a unique identifier, and to maintain in the memory a list of the identifiers of the clients who are entitled to access the application on the server, the list including a predetermined number of slots,
wherein the processor is further adapted, upon receiving a message from a given client among the plurality of the clients, the message including a request submitted by the client to access the application on the server and including a given session cookie issued to the given client, to permit the given client to access the application, responsively to the request, only if the identifier included in the given session cookie appears on the list or if at least one of the slots on the list is available to receive the given identifier.

There is further provided, in accordance with an embodiment of the present invention, a server for running a software application provided by a software vendor to an operator of the server under license, the server including:
a memory, which is adapted to store software code provided in an encoded form by the software vendor, for use in running the software application, and to store a license file, which specifies license conditions determined by the software vendor, including a limitation on a maximum number of clients permitted to access the application concurrently on the server; and
a processor, which is adapted to run the application by decoding the software code using a license control component, which permits the application to run subject to the conditions specified in the license file, such that upon receiving a request from a client to access the application on the server, the processor processes the request using the license control component, so as to permit the client to access the application subject to the limitation on the maximum number of the clients.

There is moreover provided, in accordance with an embodiment of the present invention, a computer software product, including a computer-readable medium in which program instructions are stored, which instructions, when read by a server, cause the server to read software code provided in an encoded form by a software vendor for use in running a software application, and to decode the software code subject to terms of a license determined by the software vendor so as to run the software application, the instructions further causing the server to provide respective identifiers to a plurality of clients seeking to access the application on the server, while maintaining a list of the identifiers of the clients who are entitled to access the application on the server, the list including a number of slots determined by the terms of the license, such that upon receiving a request submitted by a given client among the plurality of the clients to access the application on the server, the request including a given identifier issued to the given client, the server permits the given client to access the application, responsively to the request, only if the given identifier appears on the list or if at least one of the slots on the list is available to receive the given identifier.

There is additionally provided, in accordance with an embodiment of the present invention, a computer software product, including a computer-readable medium in which program instructions are stored, which instructions, when read by a server, cause the server to run a software application and to issue respective session cookies to a plurality of clients seeking to access the application on the server, each of the session cookies including a unique identifier, wherein the instructions further cause the server to maintain in the memory a list of the identifiers of the clients who are entitled to access the application on the server, the list including a predetermined number of slots, such that upon receiving a message from a given client among the plurality of the clients, the message including a request submitted by the client to access the application on the server and including a given session cookie issued to the given client, the server permits the given client to access the application, responsively to the request, only if the identifier included in the given session cookie appears on the list or if at least one of the slots on the list is available to receive the given identifier.

There is furthermore provided, in accordance with an embodiment of the present invention, a computer software product, including a computer-readable medium in which program instructions are stored, which instructions, when read by a server, cause the server to read software code provided in an encoded form by a software vendor under license to an operator of a server for use in running a software application, and to read a license file, which specifies license conditions determined by the software vendor including a limitation on a maximum number of clients permitted to access the application concurrently on the server, wherein the instructions cause the server to run the software application by decoding the software code using a license control component, which permits the application to run subject to the conditions specified in the license file, such that upon receiving a request from a client to access the application on the server, the license control component processes the request so as to permit the client to access the application subject to the limitation on the maximum number of the clients.

The present invention will be more fully understood from the following detailed description of the embodiments thereof, taken together with the drawings in which:

### BRIEF DESCRIPTION OF THE DRAWINGS

FIG. 1 is a block diagram that schematically illustrates a system for running a client/server application on a network, in accordance with an embodiment of the present invention;

FIG. 2 is a schematic representation of an access list maintained in a license file, in accordance with an embodiment of the present invention; and

FIG. 3 is a flow chart that schematically illustrates a method for controlling client access to an application running on a server, in accordance with an embodiment of the present invention.

### DETAILED DESCRIPTION OF EMBODIMENTS

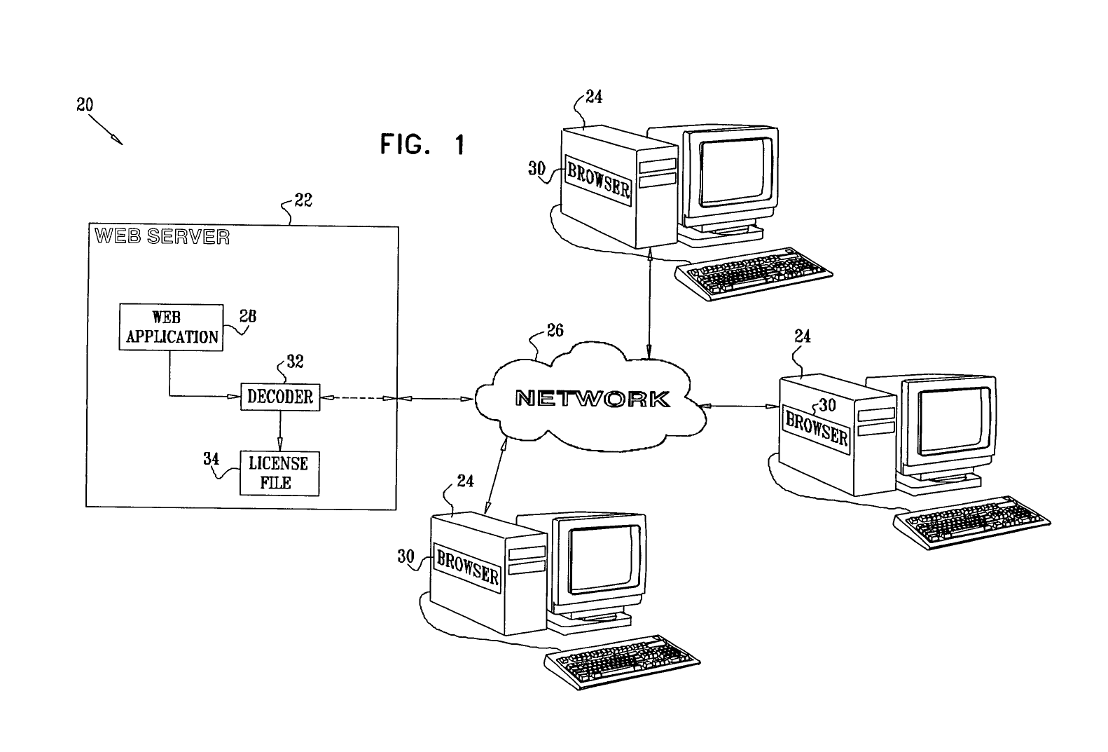

FIG. 1 is a block diagram that schematically illustrates a system 20 for running a client/server application, in accordance with an embodiment of the present invention. In this embodiment, a Web application 28 runs on a Web server 22. The application is accessed by clients 24 via a network 26, such as the Internet, using Web browsers 30 and the Hypertext Transfer Protocol (HTTP), as is known in the art. For the sake of the present example, it is assumed that server 22 is a general-purpose computer running Web server software over a standard operating system, such as UNIX® or Windows®, and that application 28 is written in a suitable scripting language, such as PHP or Microsoft® ASP.NET. The principles of the present invention, however, may similarly be applied, mutatis mutandis, to other types of network-based client/server applications that use request/response protocols, like HTTP, and to server applications that are written in other suitable programming languages.

Web application 28 is provided to the operator of server 22 under license by a third-party vendor. The software code for application 28 is typically compiled into object code or is otherwise encoded and/or obfuscated by the vendor so as to prevent the operator of the server and other parties from tampering with the code. For example, the application vendor may have developed application 28 using PHP, and then encoded the application software using a suitable encoding tool (not shown), such as the above-mentioned Zend Encoder. The encoding tool also sets a predetermined flag in the encoded software, indicating that the software should be allowed to run on a computer only if there is a valid license file 34 present in the computer memory.

In order to run application 28, server 22 must invoke a decoder 32, such as the Zend Optimizer™, which is able to decipher the application software so that it runs on the server. In addition to decoding the application code, decoder 32 serves as the license control component on server 22. Upon reading the application code on the server, decoder 32 discovers that the license flag in the code is set. In response to this flag, the decoder reads license file 34, which is a secure, digitally-signed file provided by the software vendor. The license file specifies license conditions, which are determined by the software vendor at the time of sale of the application software. Only the software vendor can change these conditions, using the appropriate digital signature. The license file specifies, inter alia, the maximum number of clients 24 who are allowed to access application 28 concurrently. Typically, the license file also includes other, conventional license limitations, such as the identity of server 22 and the expiration date of the license. Decoder 32 will start to run application 28 on server 22 only after ascertaining that license file 34 contains a valid license. While application 28 is running, decoder 32 will allow no more than the number of clients specified by the software vendor to access the application concurrently, using the mechanisms described below to control application access.

As noted above, server 22 typically comprises a general-purpose computer, running a standard operating system and Web server software, over which application 28 and decoder 32 run. Alternatively, server 22 may comprise a cluster of several machines, which share the load of serving clients 24, as is known in the art. The software for application 28 and decoder 32, as well as license file 34, may be downloaded to server 22 in electronic form, over a network, for example, or it may alternatively be supplied on tangible media, such as CD-ROM. In the case of multiple, clustered server machines, each machine may have its own license file 34, or alternatively, the license file may be held in shared memory, such as in shared RAM or on a shared disk, to be accessed by all the machines. In the latter case, the different machines may share the same quota of clients, as provided in the license file.

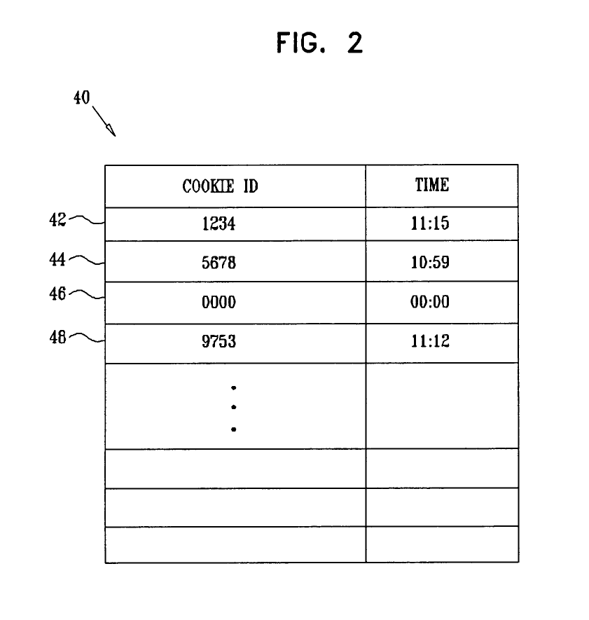

FIG. 2 a is schematic representation of an access list 40 maintained on server 22, in accordance with an embodiment of the present invention. List 40 comprises multiple slots (or entries) 42, 44, 46, 48, . . . . The number of slots in the list is equal to the maximum number of clients 24 who are allowed to access application 28 on server 22 concurrently. Each client 24 seeking to access application 28 is issued an identifier, typically in the form of a session cookie, as described in greater detail hereinbelow. Each cookie includes a unique ID code. When the client submits a request to server 22 to access application 28, in the form of a suitable HTTP request, for example, the request will contain the session cookie. Decoder 32 checks list 40 to determine whether the cookie ID code appears in one of the slots. If not, the decoder looks for a vacant slot in list 40 (such as slot 46, with default ID number 0000), and places the cookie ID code in the slot.

Each slot 42, 44, 46, 48, . . . , also includes a timestamp, indicating the time at which the client with this ID code last accessed application 28. When a client asks to access application 28, if decoder 32 does not find the client's cookie ID in list 40 and does not find any vacant slots, the decoder may look for an entry with a “stale” timestamp, such as slot 44 in the example shown in FIG. 2. It may then overwrite this entry with the current client's cookie ID, so that the current client can access the application. Alternatively or additionally, the decoder may periodically clear slots in list 40 whose timestamps are older than some predetermined limit. Clients with stale timestamps have probably gone on to some other activity and are no longer using application 28. Further alternatively or additionally, if application 28 allows clients to log off when finished, decoder 32 may clear the corresponding slots in list 40 when the clients log off.

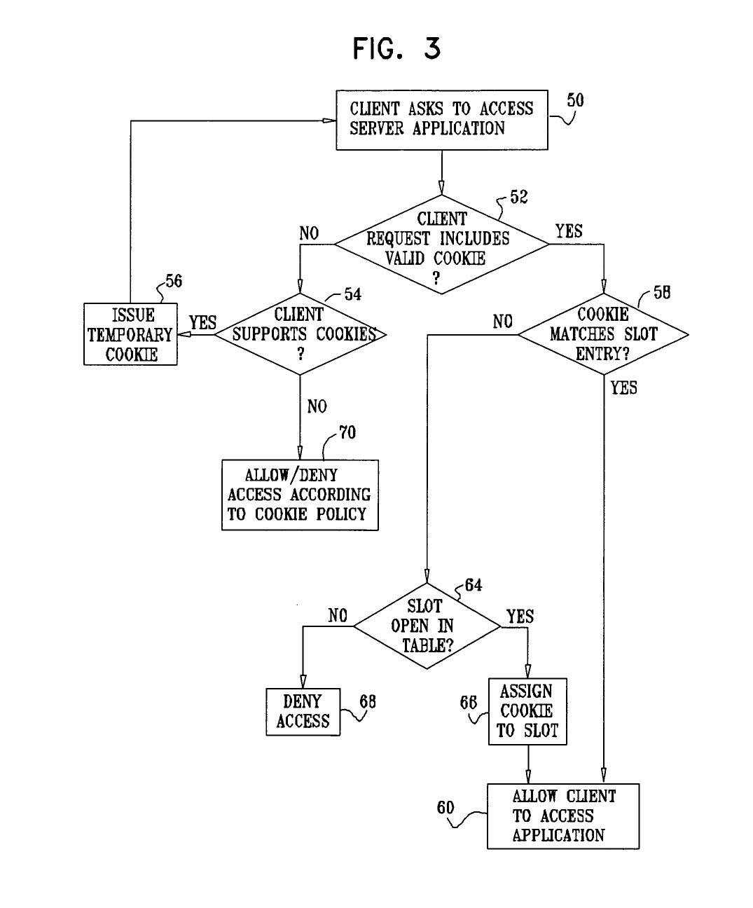

FIG. 3 is a flow chart that schematically illustrates a method used by decoder 32 in controlling access by clients 24 to application 28 running on server 22, in accordance with an embodiment of the present invention. The method is initiated by decoder 32 whenever one of clients 24 submits a request to access application 28, at a client request step 50. In the Web context, as noted above, the client request is typically in the form of a HTTP request. Decoder 32 checks the request to ascertain whether it contains a valid session cookie, at a cookie validity checking step 52. Such a cookie would have been issued to this client upon an earlier access request, and would typically include a valid cookie ID and a timestamp indicating when the cookie was issued. If the timestamp of the cookie checked at step 52 is older than some predetermined limit, the decoder classifies the cookie as invalid.

If the client request does not contain a valid cookie, it is possible that this client's browser 30 is not configured to support cookies. Decoder 32 checks whether this client supports cookies, typically using methods of HTTP interaction described below, at a cookie support verification step 54. Assuming browser 30 on client 24 is configured for cookie support (or until server 22 has ascertained at step 58 that this client does not support cookies), decoder 32 causes a session cookie to be issued to the client, at a cookie issuance step 56. The cookie is typically issued to client 24 by server 22 in a HTTP response, which also prompts the client to submit a new request to access application 28. For example, the response may cause the client browser to automatically refresh the current opening page of the application.

In any case, upon receiving the next HTTP request from client 24, decoder 32 processes the new request at step 50. When a client first attempts to access application 28, thus initiating a new application session, the client will generally not have a valid session cookie to submit and will be directed to receive a session cookie at step 56, as described above. On the other hand, after the client has completed the first interaction cycle and received the cookie at step 56, decoder 32 will find at subsequent iterations through step 52 that the new client request does contain a valid cookie. In this case, decoder 32 checks the cookie ID against list 40, at a slot checking step 58. If the cookie ID matches the entry in one of slots 42, 44, 46, 48, . . . , decoder 32 allows the client to access application 28 in the normal fashion, at an application access step 60.

If decoder 32 finds at step 58, however, that there is no entry in list 40 that matches the current cookie ID, it attempts to find an open slot in the list into which the cookie ID can be inserted, at a slot seeking step 64. If a slot is found, decoder 32 inserts the client's cookie ID into the slot, at a slot insertion step 66, and then permits the client to access application 28 at step 56. For example, the decoder may, at this stage, insert the new cookie ID into vacant slot 46 (FIG. 2). Alternatively, if there are no vacant slots, the decoder may search list 40 for a slot with a stale timestamp, such as slot 44, and may replace the cookie ID listed in this slot with the new ID (and new timestamp) of the current client.

On the other hand, if decoder 32 finds at step 64 that there are no slots available in list 40, it denies client 24 access to application 28, at an access denial step 68. Server 22 may at this point issue a message to client 24 of the form, “Application currently unavailable, try again later,” for example. Alternatively, for applications with many simultaneous users and short interaction times, the server may simply wait until a slot becomes available, and then serve the request. Meanwhile, the client waits for the server to respond. As a further alternative, server 22 may prompt browser 30 on client 24 to retry its access request automatically after a short period, until a slot becomes available. In any case, the mechanism of steps 64 and 68 limits the number of clients who may access application 28 simultaneously to the number of slots in list 40.

Returning now to step 58, various methods may be used to determine that client 24 does not support cookies. When a client first accessing the opening page of application 28, at step 50, does not present a valid session cookie, decoder 32 may not yet be able to ascertain whether or not the client supports cookies. After the client has been issued a session cookie at step 56, however, and has been directed to access the next page of application 28, it is expected that the client request to access this next page will include a session cookie. Thus, whereas decoder 32 may permit clients to access the opening page of application 28 without presenting a valid session cookie, if a client attempts to access the next page of the application without a session cookie, the decoder will conclude that this client does not support cookies. Alternatively, decoder 32 may implement other methods of cookie support detection known in the art.

Upon discovering that a given client 24 is not configured to support cookies, decoder 32 may simply deny the client access to application 28, at an access denial step 70. In this case, server 22 may send a message to the client indicating that cookie support is required in order to access this application.

Alternatively, decoder 32 may use a different method, which does not require cookies, to assign and then verify the client identifier. For example, the Web pages sent from server 22 to browser 30 may be analyzed in order to find links with embedded URLs that back-reference to application 28. Every such URL is then dynamically modified by decoder 32 to include the assigned client ID. For instance, if the client has been assigned ID=123, and the home page of application “foo” contains links to www.foo.com/login.php and www.foo.com/articles.php, these URLs may be modified as follows to include the ID: www.foo.com/login.php?ID=123 and www.foo.com/articles.php?ID=123. When a user of client 24 clicks on one of the links, the browser 30 on client 24 will generate a HTTP request containing the modified URL. Decoder 32 reads this request in order to determine the client ID and to decide whether to allow the client to access application 28. This method is compatible with all browsers, and does not require cookies. It may thus be used by decoder 32 in all client interactions or, alternatively, only for those clients that do not support cookies.

Further alternatively, decoder 32 may be configured to allow non-cookie-enabled clients to access the application freely. Since the decoder is unable to keep track of such non-cookie clients in the framework of list 40, however, these clients may be served in addition to the quota of slots in the list. The policy as to whether or not to serve non-cookie clients may be set by the application software vendor as a part of the license conditions recorded in license file 34.

A further point to be noted regarding the method of FIG. 3 is that issuance of the session cookie at step 56 and assignment of the cookie to a slot at step 66 occur in different, successive cycles of the method. If steps 64 and 66 were to follow immediately after step 56, it is possible that cookies issued to non-cookie-supporting clients would be entered in vacant slots in list 40. In fact, the same non-cookie-supporting client could access application 28 multiple times, and be issued multiple cookies, all of which would be entered in list 40. The slots of the table could thus be filled up with unused cookies, leading to “starvation” of other clients. For this reason, in the method of FIG. 3, any given cookie ID that is issued by decoder 32 is entered in table 40 only after a client has actually returned the cookie in a subsequent access request.

Although the embodiments described above are directed mainly to the Web environment and make use of features of HTTP and Web browsers known in the art, the principles of the present invention may similarly be applied to control access to other types of client/server applications that are capable of serving multiple clients concurrently and use appropriate types of request/response mechanisms to support this sort of access control. It will thus be appreciated that the embodiments described above are cited by way of example, and that the present invention is not limited to what has been particularly shown and described hereinabove. Rather, the scope of the present invention includes both combinations and subcombinations of the various features described hereinabove, as well as variations and modifications thereof which would occur to persons skilled in the art upon reading the foregoing description and which are not disclosed in the prior art.

1. A method for controlling access to a software application, the method comprising:
receiving software code in an encoded form from a software vendor, for use in running the software application on a server;
decoding the software code subject to terms of a license determined by the software vendor so as to run the software application on the server;
providing respective identifiers to a plurality of clients seeking to access the application on the server;
maintaining a list of the identifiers of the clients who are entitled to access the application on the server, the list comprising a number of slots determined by the terms of the license;
receiving a request submitted by a given client among the plurality of the clients to access the application on the server, the request comprising a given identifier issued to the given client; and
permitting the given client to access the application, responsively to the request, only if the given identifier appears on the list or if at least one of the slots on the list is available to receive the given identifier.

2. The method according to claim 1, wherein the number of slots is defined in a license file provided by the software vendor, and wherein decoding the software code comprises decoding the software code using a license control component, which reads the license file and maintains the list of the identifiers.

3. The method according to claim 1, wherein the software code is written in a scripting language, and is then encoded by the software vendor.

4. The method according to claim 1, wherein providing the respective identifiers comprises sending cookies to the clients over a network, and wherein receiving the request comprises receiving a message from the given client over the network, wherein the message comprises one of the cookies that is issued to the given client.

5. The method according to claim 4, wherein the cookies comprise session cookies.

6. The method according to claim 4, wherein receiving the message comprises receiving a Hypertext Transfer Protocol (HTTP) request.

7. The method according to claim 1, wherein receiving the request comprises receiving a Hypertext Transfer Protocol (HTTP) request, and wherein permitting the given client to access the application comprises sending a HTTP response to the client.

8. The method according to claim 7, wherein providing the respective identifiers comprises generating a uniform resource locator (URL) indicative of the given identifier issued to the given client, so as to cause the given client to insert the given identifier in the HTTP request.

9. The method according to claim 1, wherein providing the respective identifiers comprises:
receiving a first request from the given client to access the application on the server, wherein the first request does not include a valid identifier; and
issuing the given identifier to the given client in response to the first request,
wherein receiving the request comprising the given identifier comprises receiving a second request from the given client to access the application subsequent to the first request, the second request comprising the given identifier.

10. The method according to claim 9, wherein maintaining the list comprises entering the given identifier in one of the slots on the list, if at least one of the slots is available, after receiving the second request.

11. The method according to claim 1, wherein maintaining the list comprises, upon determining that the given identifier does not appear on the list but one of the slots on the list is available, and permitting the given client to access the application, entering the given identifier in the available one of the slots.

12. The method according to claim 1, wherein permitting the given client to access the application comprises denying the given client access to the application when all the slots on the list are occupied by the identifiers of others of the clients who are accessing the application.

13. The method according to claim 12, wherein maintaining the list comprises entering timestamps in the slots, indicating respective times at which the clients last accessed the application, and wherein permitting the given client to access the application comprises clearing one of the slots that contains a stale timestamp, and permitting the given client to access the application while entering the given identifier in the one of the slots that has been cleared.

14. A method for controlling access to a software application, the method comprising:
running the software application on a server;
issuing respective session cookies from the server to a plurality of clients seeking to access the application on the server, each of the session cookies comprising a unique identifier;
maintaining a list of the identifiers of the clients who are entitled to access the application on the server, the list comprising a predetermined number of slots;
receiving at the server a message from a given client among the plurality of the clients, the message comprising a request submitted by the client to access the application on the server and comprising a given session cookie issued to the given client; and
permitting the given client to access the application, responsively to the request, only if the identifier comprised in the given session cookie appears on the list or if at least one of the slots on the list is available to receive the given identifier.

15. The method according to claim 14, wherein receiving the message comprises receiving a Hypertext Transfer Protocol (HTTP) request.

16. A method for controlling access to a software application, the method comprising:
providing a software application under license from a software vendor to an operator of a server, the application comprising software code provided in an encoded form and a license file, which specifies license conditions including a limitation on a maximum number of clients permitted to access the application concurrently on the server;
running the application on the server by decoding the software code using a license control component, which permits the application to run subject to the conditions specified in the license file;
receiving a request from a client to access the application on the server; and
processing the request using the license control component, so as to permit the client to access the application subject to the limitation on the maximum number of the clients.

17. The method according to claim 16, wherein the software code is written in a scripting language, and is then encoded by the software vendor.

18. The method according to claim 16, wherein receiving the request comprises receiving a message comprising an identifier issued to the client by the server, and wherein processing the request comprises comparing the identifier to a list of identifiers maintained on the server, the list having a number of slots for receiving the identifiers equal to the maximum number of the clients specified in the license file.

19. The method according to claim 18, wherein receiving the message comprises receiving a Hypertext Transfer Protocol (HTTP) request containing the identifier.

20. The method according to claim 19, wherein the identifier comprises a session cookie.

21. The method according to claim 19, wherein running the application comprises sending the client a uniform resource locator (URL) indicative of the identifier, so as to cause the client to insert the identifier in the HTTP request.

22. The method according to claim 16, wherein the maximum number of the clients is substantially less than a total number of the clients who may access the application on the server at different times.

23. A server for running a software application, the server comprising:
a memory, which is arranged to store software code provided in an encoded form by a software vendor, for use in running the software application; and
a processor, which is adapted to decode the software code subject to terms of a license determined by the software vendor so as to run the software application, and to provide respective identifiers to a plurality of clients seeking to access the application on the server while maintaining in the memory a list of the identifiers of the clients who are entitled to access the application on the server, the list comprising a number of slots determined by the terms of the license,
wherein the processor is further adapted, upon receiving a request submitted by a given client among the plurality of the clients to access the application on the server, the request comprising a given identifier issued to the given client, to permit the given client to access the application, responsively to the request, only if the given identifier appears on the list or if at least one of the slots on the list is available to receive the given identifier.

24. The server according to claim 23, wherein the processor is adapted to determine the number of slots to be comprised in the list based on a limit defined in a license file provided by the software vendor, and to decode the software code using a license control software component running on the processor, which maintains the list of the identifiers.

25. The server according to claim 23, wherein the software code is written in a scripting language, and is then encoded by the software vendor.

26. The server according to claim 23, wherein the respective identifiers comprise cookies, which are sent by the processor to the clients over a network, and wherein the request comprises a message received from the given client over the network, and the message comprises one of the cookies that is issued to the given client.

27. The server according to claim 26, wherein the cookies comprise session cookies.

28. The server according to claim 26, wherein the message comprises a Hypertext Transfer Protocol (HTTP) request.

29. The server according to claim 23, wherein the request comprises a Hypertext Transfer Protocol (HTTP) request, and wherein the processor is adapted to send a HTTP response to the client in accordance with the application.

30. The server according to claim 29, wherein the processor is adapted to generate a uniform resource locator (URL) indicative of the given identifier issued to the given client, so as to cause the given client to insert the given identifier in the HTTP request.

31. The server according to claim 23, wherein the processor is adapted, responsively to receiving a first request from the given client to access the application on the server, wherein the first request does not include a valid identifier, to issue the given identifier to the given client, and wherein the request comprising the given identifier comprises a second request received from the given client, subsequent to the first request.

32. The server according to claim 31, wherein the processor is adapted to enter the given identifier in one of the slots on the list, if at least one of the slots is available, after receiving the second request.

33. The server according to claim 23, where the processor is adapted, upon determining that the given identifier does not appear on the list but one of the slots on the list is available, and permitting the given client to access the application, to enter the given identifier in the available one of the slots.

34. The server according to claim 23, wherein the processor is adapted to deny the given client access to the application when all the slots on the list are occupied by the identifiers of others of the clients who are accessing the application.

35. The server according to claim 34, wherein the processor is adapted to enter timestamps in the slots, indicating respective times at which the clients last accessed the application, and to clear one of the slots that contains a stale timestamp, so as to permit the given client to access the application while entering the given identifier in the one of the slots that has been cleared.

36. A server for running a software application, the server comprising:
a memory; and
a processor, which is adapted to run the software application, and which is further adapted to issue respective session cookies to a plurality of clients seeking to access the application on the server, each of the session cookies comprising a unique identifier, and to maintain in the memory a list of the identifiers of the clients who are entitled to access the application on the server, the list comprising a predetermined number of slots,
wherein the processor is further adapted, upon receiving a message from a given client among the plurality of the clients, the message comprising a request submitted by the client to access the application on the server and comprising a given session cookie issued to the given client, to permit the given client to access the application, responsively to the request, only if the identifier comprised in the given session cookie appears on the list or if at least one of the slots on the list is available to receive the given identifier.

37. The server according to claim 36, wherein the message comprises a Hypertext Transfer Protocol (HTTP) request.

38. A server for running a software application provided by a software vendor to an operator of the server under license, the server comprising:
a memory, which is adapted to store software code provided in an encoded form by the software vendor, for use in running the software application, and to store a license file, which specifies license conditions determined by the software vendor, including a limitation on a maximum number of clients permitted to access the application concurrently on the server; and
a processor, which is adapted to run the application by decoding the software code using a license control component, which permits the application to run subject to the conditions specified in the license file, such that upon receiving a request from a client to access the application on the server, the processor processes the request using the license control component, so as to permit the client to access the application subject to the limitation on the maximum number of the clients.

39. The server according to claim 38, wherein the software code is written in a scripting language, and is then encoded by the software vendor.

40. The server according to claim 38, wherein the request received from the client comprises a message comprising an identifier issued to the client by the processor, and wherein the processor is adapted to compare the identifier to a list of identifiers maintained in the memory in order to determine whether to permit the client to access the application, the list having a number of slots for receiving the identifiers equal to the maximum number of the clients specified in the license file.

41. The server according to claim 40, wherein the message comprises a Hypertext Transfer Protocol (HTTP) request containing the identifier.

42. The server according to claim 41, wherein the identifier comprises a session cookie.

43. The server according to claim 42, wherein the processor is adapted to send the client a uniform resource locator (URL) indicative of the identifier, so as to cause the client to insert the identifier in the HTTP request.

44. The server according to claim 38, wherein the maximum number of the clients is substantially less than a total number of the clients who may access the application on the server at different times.

45. A computer software product, comprising a computer-readable medium in which program instructions are stored, which instructions, when read by a server, cause the server to read software code provided in an encoded form by a software vendor for use in running a software application, and to decode the software code subject to terms of a license determined by the software vendor so as to run the software application, the instructions further causing the server to provide respective identifiers to a plurality of clients seeking to access the application on the server, while maintaining a list of the identifiers of the clients who are entitled to access the application on the server, the list comprising a number of slots determined by the terms of the license, such that upon receiving a request, submitted by a given client among the plurality of the clients to access the application on the server, the request comprising a given identifier issued to the given client, the server permits the given client to access the application, responsively to the request, only if the given identifier appears on the list or if at least one of the slots on the list is available to receive the given identifier.

46. The product according to claim 45, wherein the instructions cause the server to determine the number of slots to be comprised in the list based on a limit defined in a license file provided by the software vendor, and to decode the software code using a license control software component running on the server, which maintains the list of the identifiers.

47. The product according to claim 45, wherein the software code is written in a scripting language, and is then encoded by the software vendor.

48. The product according to claim 45, wherein the respective identifiers comprise cookies, which are sent by the server to the clients over a network, and wherein the request comprises a message received from the given client over the network, and the message comprises one of the cookies that is issued to the given client.

49. The product according to claim 48, wherein the cookies comprise session cookies.

50. The product according to claim 48, wherein the message comprises a Hypertext Transfer Protocol (HTTP) request.

51. The product according to claim 45, wherein the request comprises a Hypertext Transfer Protocol (HTTP) request, and wherein the instructions cause the server to send a HTTP response to the client in accordance with the application.

52. The product according to claim 51, wherein the instructions cause the server to generate a uniform resource locator (URL) indicative of the given identifier issued to the given client, so as to cause the given client to insert the given identifier in the HTTP request.

53. The product according to claim 45, wherein the instructions cause the server, responsively to receiving a first request from the given client to access the application on the server, wherein the first request does not include a valid identifier, to issue the given identifier to the given client, and wherein the request comprising the given identifier comprises a second request received from the given client, subsequent to the first request.

54. The product according to claim 53, wherein the instructions cause the server to enter the given identifier in one of the slots on the list, if at least one of the slots is available, after receiving the second request.

55. The product according to claim 45, where the instructions cause the server, upon determining that the given identifier does not appear on the list but one of the slots on the list is available, and permitting the given client to access the application, to enter the given identifier in the available one of the slots.

56. The product according to claim 45, wherein the instructions cause the server to deny the given client access to the application when all the slots on the list are occupied by the identifiers of others of the clients who are accessing the application.

57. The product according to claim 56, wherein the instructions cause the server to enter timestamps in the slots, indicating respective times at which the clients last accessed the application, and to clear one of the slots that contains a stale timestamp, so as to permit the given client to access the application while entering the given identifier in the one of the slots that has been cleared.

58. A computer software product, comprising a computer-readable medium in which program instructions are stored, which instructions, when read by a server, cause the server to run a software application and to issue respective session cookies to a plurality of clients seeking to access the application on the server, each of the session cookies comprising a unique identifier, wherein the instructions further cause the server to maintain in the memory a list of the identifiers of the clients who are entitled to access the application on the server, the list comprising a predetermined number of slots, such that upon receiving a message from a given client among the plurality of the clients, the message comprising a request submitted by the client to access the application on the server and comprising a given session cookie issued to the given client, the server permits the given client to access the application, responsively to the request, only if the identifier comprised in the given session cookie appears on the list or if at least one of the slots on the list is available to receive the given identifier.

59. The product according to claim 58, wherein the message comprises a Hypertext Transfer Protocol (HTTP) request.

60. A computer software product, comprising a computer-readable medium in which program instructions are stored, which instructions, when read by a server, cause the server to read software code provided in an encoded form by a software vendor under license to an operator of a server for use in running a software application, and to read a license file, which specifies license conditions determined by the software vendor including a limitation on a maximum number of clients permitted to access the application concurrently on the server, wherein the instructions cause the server to run the software application by decoding the software code using a license control component, which permits the application to run subject to the conditions specified in the license file, such that upon receiving a request from a client to access the application on the server, the license control component processes the request so as to permit the client to access the application subject to the limitation on the maximum number of the clients.

61. The product according to claim 60, wherein the software code is written in a scripting language, and is then encoded by the software vendor.

62. The product according to claim 60, wherein the request received from the client comprises a message comprising an identifier issued to the client by the processor, and wherein the instructions cause the server to compare the identifier to a list of identifiers maintained in the memory in order to determine whether to permit the client to access the application, the list having a number of slots for receiving the identifiers equal to the maximum number of the clients specified in the license file.

63. The product according to claim 62, wherein the message comprises a Hypertext Transfer Protocol (HTTP) request containing the identifier.

64. The product according to claim 63, wherein the identifier comprises a session cookie.

65. The product according to claim 63, wherein the instructions cause the server to send the client a uniform resource locator (URL) indicative of the identifier, so as to cause the client to insert the identifier in the HTTP request.

66. The product according to claim 63, wherein the maximum number of the clients is substantially less than a total number of the clients who may access the application on the server at different times.
